(19) United States
(12) Patent Application Publication
(10) Pub. No.: US 2020/0081467 A1
(43) Pub. Date: Mar. 12, 2020

(54) GYRATOR-BASED LOW-DROPOUT (LDO) REGULATOR

(71) Applicant: QUALCOMM Incorporated, San Diego, CA (US)

(72) Inventors: Anqiao HU, Chandler, AZ (US); Michael John STORY, Cambridge (GB)

(21) Appl. No.: 16/124,466

(22) Filed: Sep. 7, 2018

(51) Int. Cl. G05F 1/575

(52) U.S. Cl. CPC G05F 1/575

(57) ABSTRACT

Certain aspects of the present disclosure generally relate to a regulator circuit. For example, the regulator circuit may include a first current source coupled between a voltage rail and an output of the regulator circuit. The regulator circuit may also include a tank circuit coupled between the output of regulator circuit and a reference potential node, the tank circuit comprising a gyrator-based inductive element and a capacitive element.

### TECHNICAL FIELD

Certain aspects of the present disclosure generally relate to electronic circuits and, more particularly, to circuits for power regulation.

### BACKGROUND

Power management integrated circuits (power management ICs or PMIC) are used for managing the power requirement of a host system. A PMIC may be used in battery-operated devices, such as mobile phones, tablets, laptops, wearables, etc., to control the flow and direction of electrical power in the devices. The PMIC may perform a variety of functions for the device such as direct-current (DC)-to-DC conversion, battery charging, power-source selection, voltage scaling, power sequencing, etc. For example, a PMIC may be used for voltage regulation and may feature a low-dropout (LDO) regulator.

### SUMMARY

Certain aspects of the present disclosure generally relate to a gyrator-based low-dropout (LDO) regulator.

Certain aspects of the present disclosure provide a regulator circuit. The regulator circuit generally includes a first current source circuit coupled between a voltage rail and an output of the regulator circuit, and a tank circuit coupled between the output of the regulator circuit and a reference potential node, the tank circuit comprising a gyrator-based inductive element and a capacitive element.

Certain aspects of the present disclosure provide a regulator circuit. The regulator circuit generally includes an amplifier having a first input coupled to an output of the regulator circuit and a second input coupled to a node for providing a reference voltage (Vref), a tank circuit coupled between the output of the regulator circuit and a reference potential node, an output of the amplifier being coupled to the tank circuit, and a first current source circuit coupled between a voltage rail and the output of the regulator circuit.

Certain aspects provide a method for voltage regulation. The method generally includes generating an output voltage by sourcing a current to a tank circuit, comparing the output voltage to a reference voltage, and controlling an impedance of the tank circuit based on the comparison, thereby regulating the output voltage.

Certain aspects of the present disclosure provide a method for current regulation. The method generally includes sourcing a first current to an output node, the output node coupled to a tank circuit; sensing a second current flowing across the tank circuit; and comparing the second current with a target operating current, the sourcing of the first current comprising adjusting the first current based on the comparison.

Certain aspects of the present disclosure provide an apparatus for voltage regulation. The apparatus generally includes means for generating an output voltage by sourcing a current to a tank circuit, and means for comparing the output voltage to a reference voltage, the means for comparing comprising means for controlling an impedance of the tank circuit based on the comparison, thereby regulating the output voltage.

Certain aspects of the present disclosure provide a gyrator-based inductive element. The gyrator-based inductive element generally includes a non-gyrating transconductance stage, a first current source configured to sink a first biasing current from the non-gyrating transconductance stage, and a second current source configured to sink a second biasing current from the non-gyrating transconductance stage. In certain aspects, the gyrator-based inductive element also includes a first transistor coupled between the non-gyrating transconductance stage and the second current source. The gyrator-based inductive element may also include a gyrating transconductance stage coupled to a node between the first transistor and the second current source. In certain aspects, the first biasing current is greater than the second biasing current. In certain aspects, the non-gyrating transconductance stage comprises a second transistor, wherein the first biasing current and the second biasing current are sunk from a drain of the second transistor.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a block diagram of an example device including a power regulator, according to certain aspects of the present disclosure.

FIG. 2 illustrates an example low-dropout (LDO) regulator, in accordance with certain aspects of the present disclosure.

FIG. 3 is a graph illustrating an impedance of an example LDO regulator with respect to frequency, in accordance with certain aspects of the present disclosure.

FIG. 4A illustrates implementation detail of the example LDO regulator of FIG. 2, in accordance with certain aspects of the present disclosure.

FIG. 4B illustrates examples implementations of gyrator-based inductive elements, in accordance with certain aspects of the present disclosure.

FIG. 5 illustrates example operations for voltage regulation, in accordance with certain aspects of the present disclosure.

FIG. 6 illustrates example operations for current regulation, in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

### An Example Device

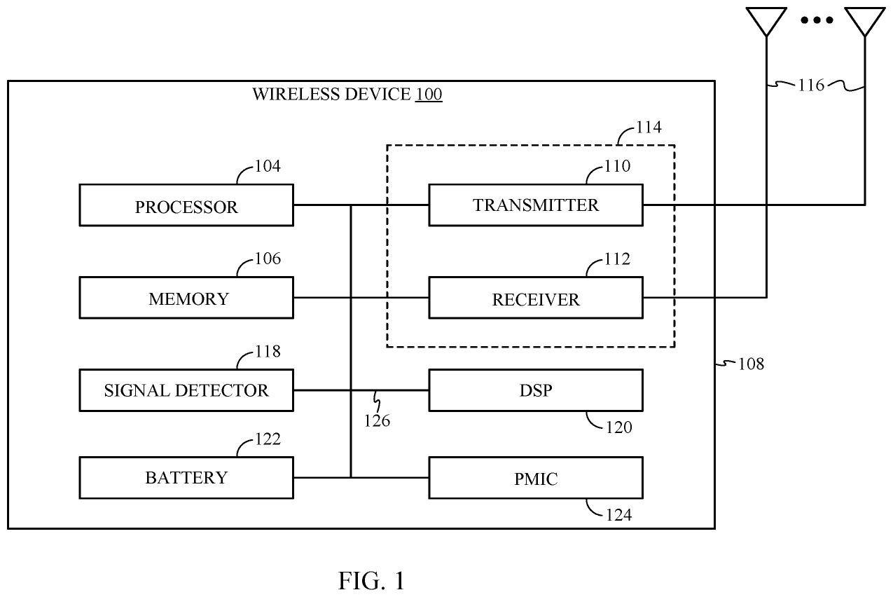

FIG. 1 illustrates a device 100. The device 100 may be a battery-operated device such as a cellular phone, a personal digital assistant (PDA), a handheld device, a wireless modem, a laptop computer, a tablet, a personal computer, etc. The device 100 is an example of a device that may be configured to implement the various systems and methods described herein.

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106. The instructions in the memory 106 may be executable to implement the methods described herein.

The device 100 may also include a housing 108 that may include a transmitter 110 and a receiver 112 to allow transmission and reception of data between the device 100 and a remote location. The transmitter 110 and receiver 112 may be combined into a transceiver 114. A plurality of transmit antennas 116 may be attached to the housing 108 and electrically coupled to the transceiver 114. The device 100 may also include (not shown) multiple transmitters, multiple receivers, and multiple transceivers.

The device 100 may also include a signal detector 118 that may be used in an effort to detect and quantify the level of signals received by the transceiver 114. The signal detector 118 may detect such signals as total energy, energy per subcarrier per symbol, power spectral density and other signals. The device 100 may also include a digital signal processor (DSP) 120 for use in processing signals.

The device 100 may further include a battery 122 used to power the various components of the device 100. The device 100 may also include a power management integrated circuit (power management IC or PMIC) 124 for managing the power from the battery to the various components of the device 100. The PMIC 124 may perform a variety of functions for the device such as DC-to-DC conversion, battery charging, power-source selection, voltage scaling, power sequencing, etc. In certain aspects, the PMIC 124 includes a voltage regulator (e.g., low-dropout (LDO) regulator) as described herein, and may be used for voltage regulation. For example, the LDO regulator as described herein may be used to provide a regulated voltage for a voltage-controlled oscillator (VCO) of the transceiver 114, which may have strict phase noise specifications and may be prone to power amplifier (PA) load pulling.

The various components of the device 100 may be coupled together by a bus system 126, which may include a power bus, a control signal bus, and a status signal bus in addition to a data bus.

### Example Low-Dropout (LDO) Regulator

Certain aspects of the present disclosure generally relate to a voltage regulator (e.g., a low-dropout (LDO) regulator). Radio-frequency (RF) blocks which may be included in the transceiver 114 may ideally be implemented with clean power supplies. Switching converters (e.g., single inductor multiple output (SIMO) converters) generate large output ripples at varying (often high) frequencies. Bill of material (BOM) costs, pin count specifications, and/or printed circuit board (PCB) and capacitor inductance often preclude the use of capacitors implemented external to integrated circuits (ICs) to reduce the output ripples. Certain aspects of the present disclosure are generally directed to a LDO regulator that may be implemented without external capacitors (e.g., external to an IC).

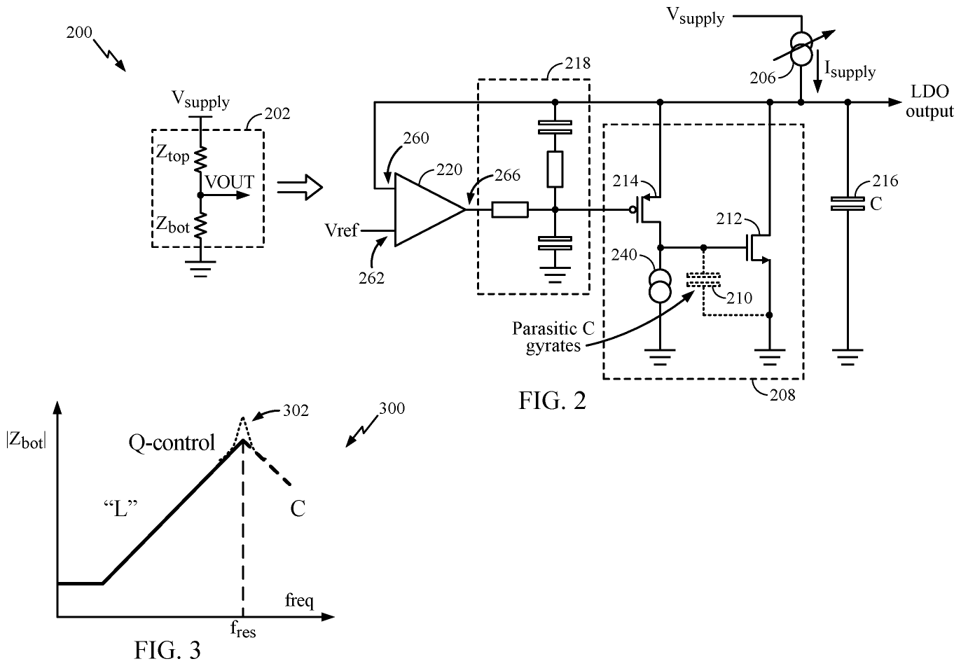

FIG. 2 illustrates an LDO regulator 200 (also referred to herein as a “regulator circuit”), in accordance with certain aspects of the present disclosure. As illustrated in FIG. 2A, the LDO regulator 200 may be implemented with a voltage divider circuit 202 for regulating a supply voltage (Vsupply) at a voltage rail. The voltage divider circuit 202 may include a top impedance (Zₜₒₚ) and a bottom impedance (Z_{bot}). Increasing Zₜₒₚ or decreasing Z_{bot} may increase the LDO power-supply rejection ratio (PSRR).

Certain aspects of the present disclosure implement Zₜₒₚ with a current source that drives current to Z_{bot}, where Z_{bot} is implemented with a parallel inductor-capacitor (LC) tank circuit. For example, the LDO regulator 200 may be implemented using a variable current source 206 (e.g., corresponding to Zₜₒₚ of the voltage divider circuit 202). Z_{bot} is implemented with an inductive element 208 synthesized using a gyrator. For example, the inductive element 208 may include a transistor 214 (e.g., p-type metal-oxide-semiconductor (PMOS) transistor), a current source 240 for sinking a current from the drain of transistor 214, and a transistor 212 (e.g., n-type metal-oxide-semiconductor (NMOS) transistor). The parasitic gate-to-source capacitance 210 of the transistor 212 gyrates to generate the inductance for the inductive element 208. The inductance (L) of the inductive element 208 may be about equal to:

$$L \approx \frac{{C}_{gs}}{{g}_{m 1} {g}_{m 2}}$$

where C_{gs} is the gate-to-source capacitance 210 of the transistor 212, gₘ₁ is the transconductance of the transistor 214, and g,ₘ₂ is the transconductance of the transistor 212. The inductive element 208 may be implemented in parallel with a capacitive element 216 to form an LC tank circuit (also referred to as a resonant circuit or tuned circuit). As used herein, a capacitive element generally refers to a component or combination of components possessing an electrical capacitance. A capacitive element may be implemented by, for example, a capacitor or a transistor. The capacitive element may have a fixed or variable capacitance. The tank circuit is coupled between the output of the LDO regulator 200 and a reference potential node (e.g., electric ground). The capacitive element 216 may be small enough to be implemented on-chip (e.g., in the same integrated circuit (IC) as the other components illustrated in FIG. 2).

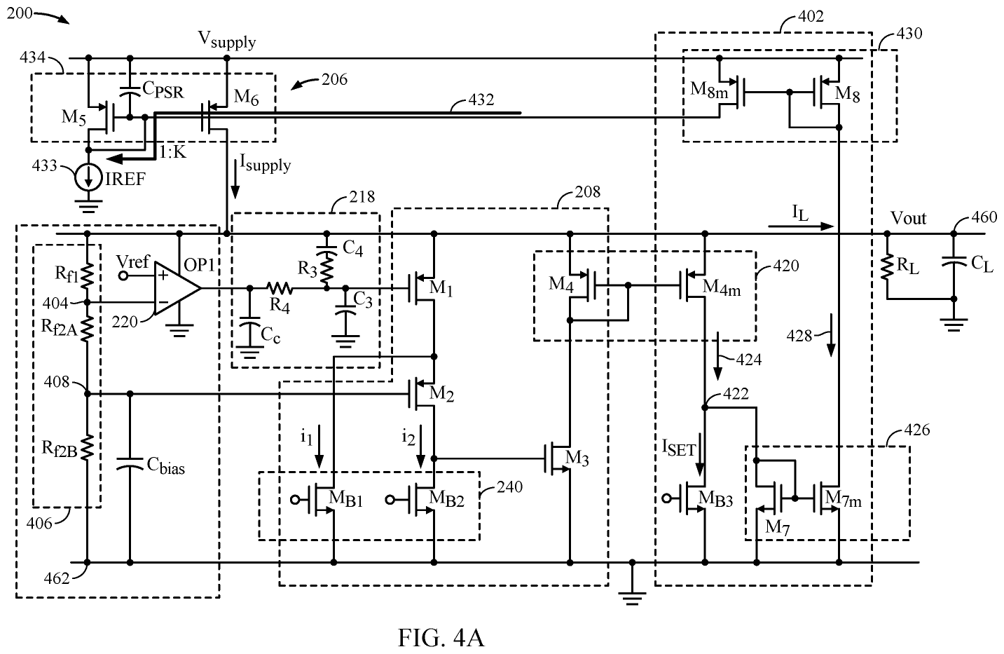

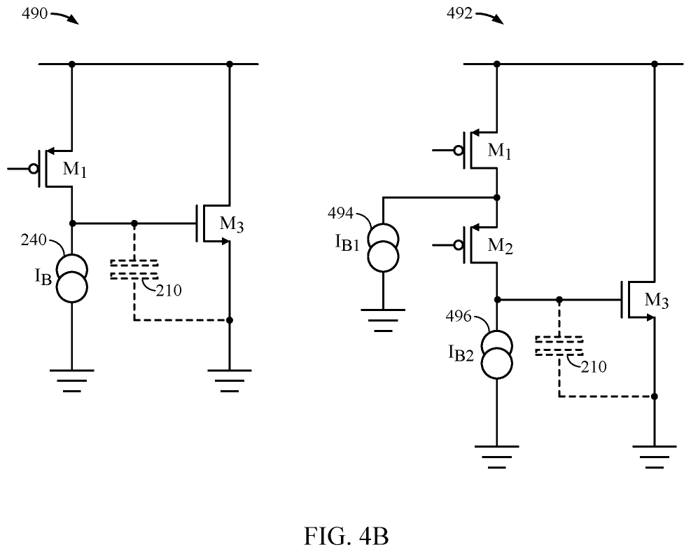

The LDO regulator 200 also includes an amplifier 220 for output voltage regulation at low frequencies (e.g., direct-current (DC) to about 300 kHz). The amplifier has a first input 260 coupled to the output of the LDO regulator 200 and a second input 262 coupled to a node 264 providing a reference voltage (Vref). The output 266 of the amplifier 220 controls the inductance of the inductive element 208 to set the voltage at the output (labeled “LDO output”) of the LDO regulator 200 based on (e.g., to be the same as) the reference voltage (Vref). For example, the output of the amplifier 220 adjusts the gate voltage of the transistor 214, adjusting the transconductance gₘ₁ of the transistor 214, which in turn adjusts the inductance of the inductive element 208. In certain aspects, a quality factor (Q) control circuit 218 (also referred to as a “dampening circuit”) may be implemented between the output of the amplifier 220 and the inductive element 208, as described with respect to FIGS. 3 and 4.

FIG. 3 is a graph 300 illustrating the absolute value of the impedance Z_{bot} with respect to frequency, in accordance with certain aspects of the present disclosure. The inductive element 208 provides low impedance for Z_{bot} at low frequencies, and the capacitive element 216 provides low impedance for Z_{bot} at high frequencies, increasing the PSRR of the LDO regulator 200. The Q control circuit 218 prevents a spike 302 in the impedance Z_{bot} at the resonant frequency (fᵣₑₛ) of the tank circuit.

FIG. 4A is a schematic diagram illustrating example implementation detail of the LDO regulator 200, in accordance with certain aspects of the present disclosure. The LDO regulator 200 provides a regulated voltage for a load that is represented by a load resistive element (R_{L}) and a load capacitive element (C_{L}) in FIG. 4A. The load capacitive element C_{L} also represents the capacitive element 216 described with respect to FIG. 2. As illustrated, the negative input of the amplifier 220 is coupled to a tap node 404 of a voltage divider circuit 406 that generates a voltage at the tap node 404 that is less than, but representative of, the output voltage (Vout) of the LDO regulator 200. The voltage divider circuit 406 includes a resistive element R_{f1} coupled between the output 460 of the LDO regulator 200 and the tap node 404, and also includes resistive elements R_{f2A} and R_{f2B} coupled between the tap node 404 and the reference potential node 462 (e.g., electric ground).

The inductive element 208 is implemented with a transistor M1 (e.g., corresponding to transistor 214 of FIG. 2) and a transistor M3 (e.g., corresponding to transistor 212 of FIG. 2). The gate-to-source capacitance of transistor M3 gyrates to provide the inductance of the inductive element 208, as described with respect to FIG. 2.

In certain aspects, the current source 240 as described with respect to FIG. 2 may be implemented using the transistors M₂, M_{B1} and M_{B2}, which may be biased to generate currents i₁ and i₂, as illustrated. The transistors M_{B1} and M_{B2} may be biased such that the current i₁ is much greater than the current i₂ to implement a small inductance for the inductive element 208, as described in more detail with respect to FIG. 4B.

FIG. 4B illustrates example implementations of gyrator-based inductive elements 490, 492, in accordance with certain aspects of the present disclosure. The gyrator-based inductive element 490 corresponds to the implementation of the gyrator-based inductive element 208 of FIG. 2, and the gyrator-based inductive element 492 corresponds to the implementation of the gyrator-based inductive element 208 of FIG. 4A. As illustrated, the gyrator-based inductive element 490 is implemented with a single current source that sinks a biasing current from a non-gyrating transconductance stage (e.g., transistor M1). The gyrator-based inductive element 490 also includes a gyrating transconductance stage (e.g., transistor M3), the gate to source capacitance 210 of which gyrates to generate the inductance of the inductive element 490, as described with respect to FIG. 2.

The gyrator-based inductive element 492 is implemented with two separate biasing current paths, each including a current source 494, 496. The current sources 494 and 496 sink biasing currents from the non-gyrating transconductance stage implemented using transistor M1. In addition, the gyrator-based inductive element 492 includes a transistor M₂ coupled between the drain of transistor M1 and the current source 496, forming a cascode device. The transistor M2 reduces parasitic capacitance in parallel with the gate to source capacitance 210 of transistor M₃, thereby allowing for a low inductance for the inductive element 208. For example, the transistor M₂ isolates parasitic capacitance associated with the current source 494 (e.g., transistor MB₁) from the gate to source capacitance 210 of transistor M₃. The current I_{B1} (e.g., corresponding to current i₁ of FIG. 4A) may be set to be much greater than the current I_{B2} (e.g., corresponding to current i₂ of FIG. 4A) to increase the isolation effect of transistors M₂.

For the transistor M₂ to properly isolate any parasitic capacitance that may be in parallel with the gate to source capacitance 210 of transistor M3, the transistor M₂ may be biased in saturation region. Thus, the gate of transistor M₂ may be driven by a signal generated at another tap node 408 of the voltage divider circuit 406 such that the transistor M₂ is biased in the saturation region, as illustrated in FIG. 4A. In certain aspects, the resistive element R_{f2B} may be coupled in parallel with a capacitive element C_{bias} to low-pass filter the voltage at the tap node 408 for biasing the gate of the transistor M₂.

The LDO regulator 200 may also include a Q control circuit 218 for improving the Q associated with the LDO regulator 200. The Q control circuit 218 includes capacitive elements C_{c} and C₃, which may be implemented to have relatively low impedance at different frequencies. For example, C₃ may be set to have low impedance (e.g., effectively a short-circuit) at a resonant frequency of the tank circuit and relatively high impedance at frequencies less than the resonant frequency of the tank circuit. C_{c} may be set to have low impedance (e.g., effectively a short-circuit) at frequencies less than the resonant frequency of the tank circuit and relatively high impedance at the resonant frequency of the tank circuit. Thus, at the resonant frequency of the tank circuit, the inductive element 208 is effectively in parallel with the capacitive element C₄ and the resistive element R₃ since the capacitive element C₃ is effectively a short circuit, reducing the impedance of Z_{bot} at the resonant frequency.

At frequencies less than the resonant frequency, the capacitive element C₃ is effectively an open circuit, and the capacitive element Cc is effectively a short circuit, resulting in the inductive element 208 being effectively in parallel with the capacitive element C₄ and both the resistive element R₃ and R₄ in series. The resistance of R₄ may be relatively large (e.g., as compared to the resistance of the R₃), and therefore, the impedance Z_{bot} may not be significantly impacted at frequencies less than the resonant frequency.

In certain aspects, the LDO regulator 200 may include a current regulation circuit 402. The current regulation circuit 402 regulates the supply current Isupply in response to variations in the load current I_{L} and based on a target desired operating current I_{SET} which may be set by biasing the transistor MB₃. For example, the LDO regulator 200 may include a current mirror 420 having a first branch (e.g., at a drain of transistor M₄) coupled between the output of the LDO regulator 200 and the transistor M3, and a second branch coupled between the output of the LDO regulator 200 and node 422. Thus, the current mirror 420 generates a current 424 that mirrors the current flowing across the inductive element 208 (e.g., the drain-to-source current of M₃).

The current 424 flows to the node 422, and thus, the difference between the current 424 and the current I_{SET} flows to a first branch of the current mirror 426 (e.g., flows to the drain of transistor M₇). The current mirror 426 generates a current 428 (e.g., drain-to-source current of transistor M₇ₘ) at the second branch of the current mirror 426, which also flows in the first branch of a current mirror 430 (e.g., is sunk from a drain of transistor M₈). A current 432 (e.g., drain-to-source current of current M₈ₘ) is then generated that mirrors the current 428.

The source-to-drain current of transistor M₅ is set based on the difference between the current 432 and a reference current (IREF) generated by a current source 433. The transistor M₅ is part of a current mirror 434, which generates the supply current (Isupply) (e.g., the source-to-drain current of transistor M₆) that mirrors the source-to-drain current of transistor M₅. The supply current Isupply is sourced from a voltage rail (Vsupply). Thus, the current regulation circuit 402 regulates the supply current Isupply based on the load current I_{L}. For example, when the load current (I_{L}) increases, the current through the inductive element 208 decreases, resulting in a decrease in the current 424, and a reduction in the drain-to-source current of transistor M₇. Therefore, the current 428 also decreases, decreasing the current 432, resulting in an increase in the source-to-drain current of transistor M₅ and the supply current Isupply. Thus, in response to an increase to the load current I_{L}, the current regulation circuit 402 increases the supply current Isupply. In a similar manner, the current regulation circuit 402 also decreases the supply current Isupply in response to a reduction of the load current I_{L}.

Certain aspects of the present disclosure provide an LDO regulator that reduces chip pin count and BOM costs since the LDO regulator may be implemented without any external capacitors (e.g., external to the chip). The LDO regulator also improves the PSRR by about 30 dB from DC to about 70 MHz, and by about 12 dB to 30 dB from DC to frequencies in the GHz range, as compared to NMOS-based LDO regulators. The LDO regulator of the present disclosure also provides stable and predictable performance.

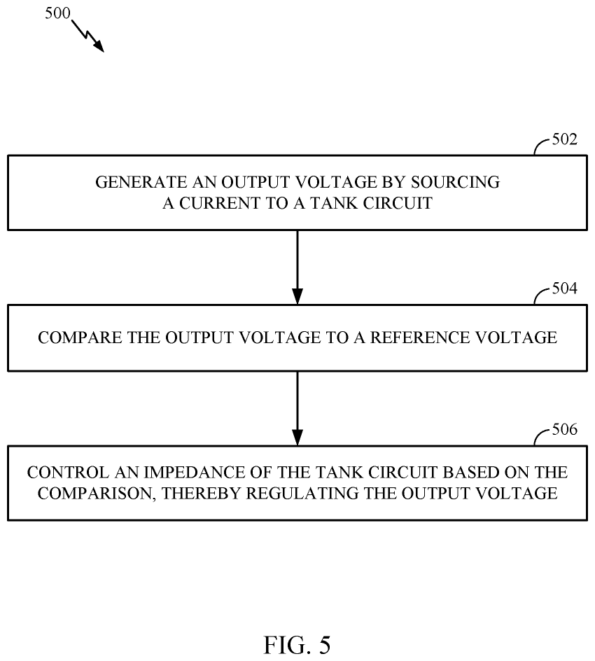

FIG. 5 illustrates example operations 500 for voltage regulation, in accordance with certain aspects of the present disclosure. The operations 500 may be performed by a circuit, such as the LDO regulator 200.

The operations 500 begin at block 502 by generating an output voltage (e.g., Vout) by sourcing a current (e.g., Isupply) to a tank circuit, and at block 504, by comparing (e.g., via the amplifier 220) the output voltage to a reference voltage (e.g., Vref). At block 506, the operations 500 also include controlling (e.g., via the amplifier 220) an impedance of the tank circuit based on the comparison, thereby regulating the output voltage.

In certain aspects, controlling the impedance of the tank circuit, at block 506, includes controlling an impedance of a gyrator-based inductive element (e.g., inductive element 208) of the tank circuit. In certain aspects, comparing the output voltage to the reference voltage, at block 504, includes comparing a voltage (e.g., at tap node 404) representing the regulated output voltage to the reference voltage.

In certain aspects, the operations 500 also include comparing a current flowing across an inductive element of the tank circuit with a target operating current (e.g., I_{SET}), and controlling the current sourced to the tank circuit based on the comparison of the current flowing across the inductive element with the target operating current. In certain aspects, the operations 500 also include reducing (e.g., via the Q control circuit 218) an impedance of the tank circuit at a resonant frequency of the tank circuit.

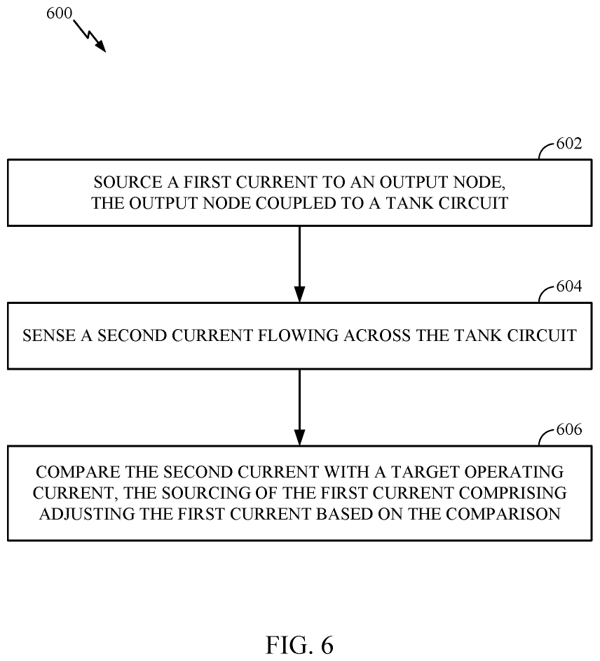

FIG. 6 illustrates example operations 600 for current regulation, in accordance with certain aspects of the present disclosure. The operations 600 may be performed by a circuit, such as the LDO regulator 200.

The operations 600 begin at block 602 by sourcing a first current (e.g., Isupply) to an output node, the output node coupled to a tank circuit, and at block 604, sensing a second current flowing across the tank circuit. At block 606, the circuit compares the second current with a target operating current (e.g., I_{SET}), the sourcing of the first current including adjusting the first current based on the comparison.

In certain aspects, the tank circuit includes an inductive element (e.g., inductive element 208) and a capacitive element, the second current flowing across the inductive element of the tank circuit. In certain aspects, the inductive element is implemented as a gyrator-based inductive element.

In certain aspects, an output voltage (e.g., Vout) is generated at the output node by the sourcing of the first a current. In this case, the operations 600 also include comparing the output voltage to a reference voltage (e.g., Vref), and controlling an impedance of the tank circuit based on the comparison, thereby regulating the output voltage. In certain aspects, the operations 600 also include reducing an impedance of the tank circuit at a resonant frequency of the tank circuit.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

In certain aspects, means for generating may comprise a current source, such as the variable current source 206. In certain aspects, means for comparing an output voltage to a reference voltage and means for controlling an impedance may comprise an amplifier, such as the amplifier 220. In certain aspects, means for comparing a current flowing across an inductive element and means for controlling current sourced to a tank circuit may comprise a current regulation circuit, such as the current regulation circuit 402. In certain aspects, means for reducing an impedance of a tank circuit comprises a Q control circuit, such as the Q control circuit 218.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with discrete hardware components designed to perform the functions described herein. The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the methods and apparatus described above without departing from the scope of the claims.

1. A regulator circuit comprising:
a first current source circuit coupled between a voltage rail and an output of the regulator circuit; and
a tank circuit coupled between the output of the regulator circuit and a reference potential node, the tank circuit comprising a gyrator-based inductive element and a capacitive element.

2. The regulator circuit of claim 1, further comprising:
an amplifier having a first input coupled to the output of the regulator circuit, a second input coupled to a node for providing a reference voltage (Vref), and an output coupled to the gyrator-based inductive element.

3. The regulator circuit of claim 2, wherein the gyrator-based inductive element comprises:
a first transistor having a source coupled to the output of the regulator circuit and a gate coupled to the output of the amplifier;
a second current source circuit coupled to a drain of the first transistor; and
a second transistor having a gate coupled to the drain of the first transistor, a drain coupled to the output of the regulator circuit, and a source coupled to the reference potential node.

4. The regulator circuit of claim 3, wherein the second current source circuit is configured to sink a current from the drain of the first transistor.

5. The regulator circuit of claim 3, further comprising a dampening circuit coupled between the output of the amplifier and the gate of the first transistor.

6. The regulator circuit of claim 5, wherein the dampening circuit comprises:
a first resistive element coupled between the output of the amplifier and the gate of the first transistor;
a second resistive element coupled between the output of the regulator circuit and the gate of the first transistor;
a first capacitive element coupled between the gate of the first transistor and the reference potential node; and
a second capacitive element, wherein the second resistive element and the second capacitive element are coupled in series between the output of the regulator circuit and the gate of the first transistor.

7. The regulator circuit of claim 6, further comprising:
a third capacitive element coupled between the output of the amplifier and the reference potential node.

8. The regulator circuit of claim 7, wherein:
the first capacitive element is configured to have a relatively low impedance at a resonant frequency of the tank circuit;
the third capacitive element is configured to have a relatively high impedance at the resonant frequency of the tank circuit;
the first capacitive element is configured to have a relatively high impedance at frequencies less than the resonant frequency of the tank circuit; and
the third capacitive element is configured to have a relatively low impedance at the frequencies less than the resonant frequency of the tank circuit.

9. The regulator circuit of claim 3, wherein the second current source circuit comprises:
a third transistor having a drain coupled to the drain of the first transistor and a source coupled to the reference potential node.

10. The regulator circuit of claim 9, wherein the second current source circuit further comprises:
a fourth transistor coupled between the drain of the first transistor and the reference potential node; and
a fifth transistor coupled between the drains of the first transistor and the third transistor, wherein a node between the third and fifth transistors is coupled to the gate of the second transistor.

11. The regulator circuit of claim 10, further comprising a voltage divider circuit coupled between the output of the regulator circuit and the reference potential node, wherein a tap node of the voltage divider circuit is coupled to a gate of the fifth transistor.

12. The regulator circuit of claim 3, further comprising a current regulation circuit comprising:
a first current mirror having a first branch coupled between the output of the regulator circuit and the second transistor;
a third current source circuit coupled to a second branch of the first current mirror;
a second current mirror having a first branch coupled to a node between the second branch of the first current mirror and the third current source circuit; and
a third current mirror having a first branch coupled between the voltage rail and a second branch of the second current mirror and having a second branch coupled to the first current source circuit.

13. The regulator circuit of claim 12, wherein the first current source circuit comprises:
a third transistor having a drain coupled to the output of the regulator circuit;
a fourth transistor having a gate coupled to a gate of the third transistor and to a drain of the fourth transistor; and
a current source coupled between the drain of the fourth transistor and the reference potential node.

14. The regulator circuit of claim 2, further comprising a voltage divider circuit having:
a first resistive element coupled between the first input of the amplifier and the output of the regulator circuit; and
a second resistive element coupled between the first input of the amplifier and the reference potential node.

15. The regulator circuit of claim 1, wherein the inductive element is coupled in parallel with the capacitive element.

16-30. (canceled)
